(19) United States
(12) Patent Application Publication
(10) Pub. No.: US 2020/0281189 A1
(43) Pub. Date: Sep. 10, 2020

(54) Mallard Hen Variable Tone Game Caller with Quick Grip

(71) Applicant: Paul Jared Nuessen, Eagan, MN (US)

(72) Inventor: Paul Jared Nuessen, Eagan, MN (US)

(21) Appl. No.: 16/294,069

(22) Filed: Mar. 6, 2019

(51) Int. Cl. A01M 31/00

(52) U.S. Cl. CPC A01M 31/004

(57) ABSTRACT

A tubular blowing tube receives a sounding barrel in one end. A longitudinal channel extending from the inner end of a sounding barrel defines a rounded support surface for a pair of reeds or reed. The joining of the longitudinal channel and rounded support surface includes four notches of each side of the channel, geometrically shaped to encourage upward air flow. The exterior portion of the sounding barrel includes a primary exhaust that allows longitudinal flow of air but also a secondary exhaust that allows perpendicular air flow. The secondary exhaust incorporates two longitudinal slits that resemble the anatomical design of a mallard hen bill underside, with geometric design to enable controlled air flow. The sounding barrel includes a recessed design quick grip around the secondary exhaust, built at a depth that allows for controlled volumetric air flow ratio between the primary and secondary exhaust ports. The recessed area around the secondary exhaust port on the sounding barrel is designed to project the air flow and sound forward in the longitudinal direction of the game caller device, while enabling the game caller operator to quickly orient the call based on the location of the recessed quick grip in the sounding barrel.

### CROSS REFERENCES TO RELATED APPLICATIONS

This application claims the benefit of Applicant's prior provisional application, No. 62/646,454, filed on Mar. 22, 2018.

### FIELD OF INVENTION

Calling devices designed to mimic animals are often used to attract wild game. This invention will involve creating a game caller that can be used to create sounds like multiple mallard hens, which can be used by bird watchers or hunters.

### Background

### Summary

The invention relates to a call for use in calling or attracting waterfowl or game. Traditionally these calls have been designed with a symmetrical blowing tube at one end and a sounding barrel that fits into the blowing tube. The sounding barrel contains a reed that vibrates in the sound chamber inside the blowing tube and a single exhaust port that air flow exits through opposite end of the mouthpiece of the blowing tube. The bore controls the air escape rate and thereby produces the desired sounds of ducks and geese. The portion of the sounding barrel extended out of the blowing tube are traditionally symmetrical and round, while also having only one exhaust port for air flow. The present invention includes an embodiment made to replicate the sounds of two distinct mallard hens using one game caller by incorporating a secondary exhaust in the sounding barrel that, when open, creates a higher pitched distinct tone compared to the tone when the secondary exhaust is closed. When the secondary exhaust is closed airflow exits only through the primary exhaust of the sounding barrel, while when the secondary exhaust is open air flows through the primary and secondary exhausts at the same time. The design and dimensions of the secondary exhaust controls the amount of air that can flow through it when both exhausts are open and is referenced in the second and third embodiments.

The second embodiment of the present invention is the secondary exhaust port of the sounding barrel is formed replicating the physical design (2 longitudinal slits) that is present in the upper bill of real mallard hens. The slits include calculated angles at the upwind and downwind sides of roughly 45° and 30° that give directional control to air flow through them thus controlling the air flow and sound to travel in a forward direction.

The third embodiment of this design is a recessed surface area surrounding the secondary exhaust in the sounding barrel, allowing the call operator to quickly identify the correct orientation of the calling device. This “quick grip” is designed not only to give the operator quick orientation of the call, but also to allow directional and volume control of the air flow through the secondary exhaust.

The fourth embodiment of this design is notches in the reed support surface of the sounding barrel of the call that allows air moving through the blowing tube to provide upward force to the call reeds, reducing the force required to move the reeds when operating the device due to the presence of moisture or condensation. These notches are present where the reed support surface merges with the longitudinally extended channel through the sounding barrel portion that is inserted into the blowing tube.

The fifth embodiment of the design includes rounded reed support surfaces in the sounding barrel of the game caller. This allows for a smaller surface contact area with the reeds, reducing the common problem of sticking incurred between the reeds and the reed support surface.

### BRIEF DESCRIPTION OF THE DRAWINGS

FIG. 1: Top view of the game caller according to one embodiment of the present invention

FIG. 2: Exploded perspective of the top view of the game caller according to one embodiment of the present invention

FIG. 3: Side view of game caller according to the invention

FIG. 4: Longitudinal sectional view of game caller according to one embodiment of the present invention

FIG. 5: Transverse sectional view of game caller according to one embodiment of the present invention

FIG. 6: Top view of sounding barrel sounding board according to one embodiment of the present invention

FIG. 7: Top view of sounding barrel secondary exhaust and recessed grip according to one embodiment of the present invention

### DETAILED DESCRIPTION AND PREFERRED EMBODIMENT

This invention is designed to mimic the sound of live mallard hens. The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description to provide a thorough understanding of the invention. However, the invention may be practiced according to the claims without some or all these specific details. For the purpose of clarity, technical material that is known in the technical fields related to the invention has not been described in detail so that the invention is not unnecessarily obscured.

As shown in FIG. 4 air is forced through the game caller mouthpiece 9 entrance at the end of the blowing tube 10 through the sound chamber 11, where it traverses across the reeds 16 causing them to resonate against the reed support surface 12. The reeds 16 are held in place often utilizing a wedge 17 into the sounding barrel 20 thus applying downward pressure to ensure contact with the reed support surface 12, which is disturbed by the air flow and causes resonation and thus creates sound. Air continues through the channel 18 of the sounding barrel 20 through the end of the blowing tube 10. On the outer extension of the sounding barrel 20 air has the opportunity to exit through the primary exhaust 22 linear to the flow through the sound chamber 11 and also perpendicularly through the secondary exhaust 32.

Traditionally reed support surface 12 is of flat design. In this invention FIG. 5 depicts the reed support surface 12 is of a slightly rounded design traveling laterally to air flow and is designed to lower the surface area the reeds 16 contact. This lowered surface area reduces the potential for the reeds 16 to stick against the reed support surface 12 when moisture is present. A secondary design aspect of the reed support surface depicted in FIGS. 2, 4, and 6 are four notches 15 of a diamond shape in a laterally angled design in each inner side of the reed support surface 12. The notches 15 extend vertically down the longitudinally extended channel 18 of the sounding barrel 20 that is inserted into the blowing tube 10. These notches 15 are designed to enable more upward air pressure to the reeds 16 when air is forced through the game caller, leading to the reeds being more easily “pushed” upward before returning downward against the reed support surface 12. As air flow travels through the sound chamber 11 and comes into contact with the reeds 16 a static friction can be required to be overcome in order to lift the reeds 16 off of a flat reed support surface. The combination of curved reed support 12 that reduces surface area, and diamond shape notches 15 that encourage air flow to travel upward thus having a lifting effect on the reeds 16, allows reeds 16 to be lifted more easily and create the vibrational frequency needed to make the desired duck sound.

As air passes through the sound chamber 11 in blowing tube 10 and through the inserted portion of the sounding barrel 20 of the game caller, the sounding barrel 20 is designed to constrict air flow, as in many wind instruments, and includes a primary exhaust 22 that air flow exits through. Most of the air flow exits the call laterally through the primary exhaust 22 of the sounding barrel, as in traditional mallard game callers, but this invention also includes a secondary exhaust in the form of two slits 32 forming the secondary exhaust that allows air flow perpendicular to the primary exhaust 22 air flow. The secondary exhaust is designed utilizing two slits 32 which resembles the physiological characteristics noticed in the underside of the upper bill in mallard hens. These two slits 32 have a length to width ratio in the lateral direction of approximately 5:1, as opposed to a geometric circle, control air flow and project the resulting sound in a more perpendicular path compared to the primary exhaust 22. The slits 32 are angularly designed to encourage air flow moving in the forward direction by incorporating approximately 45° angle 34 on the blowing tube 10 end, and approximately 30° angle 36 toward the sounding barrel primary exhaust 22 end as shown in FIG. 4. This is important because these angles control the air flow by projecting it in a more forward direction, as a live mallard hen does when making quacking noises. This secondary exhaust 32 enables air flow control—when the secondary exhaust 32 is open the resultant sound is of a noticeably different tone than when air flow is only allowed through the primary exhaust. The two different situations (open secondary exhaust and closed secondary exhaust) allow for two distinctively different tones to be produced, creating the illusion of two different mallard hens. This is important because mallard hens, much like people, do not all sound the same—different hen mallards have different pitches and tones. Throttling air flow through the secondary exhaust 32 allows for even more variable tones to be created utilizing this invention.

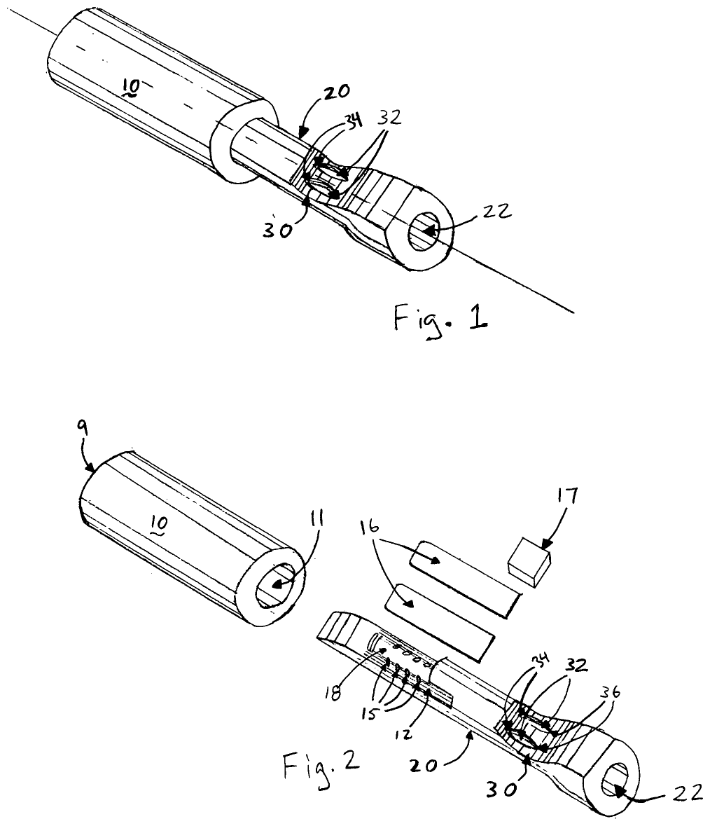

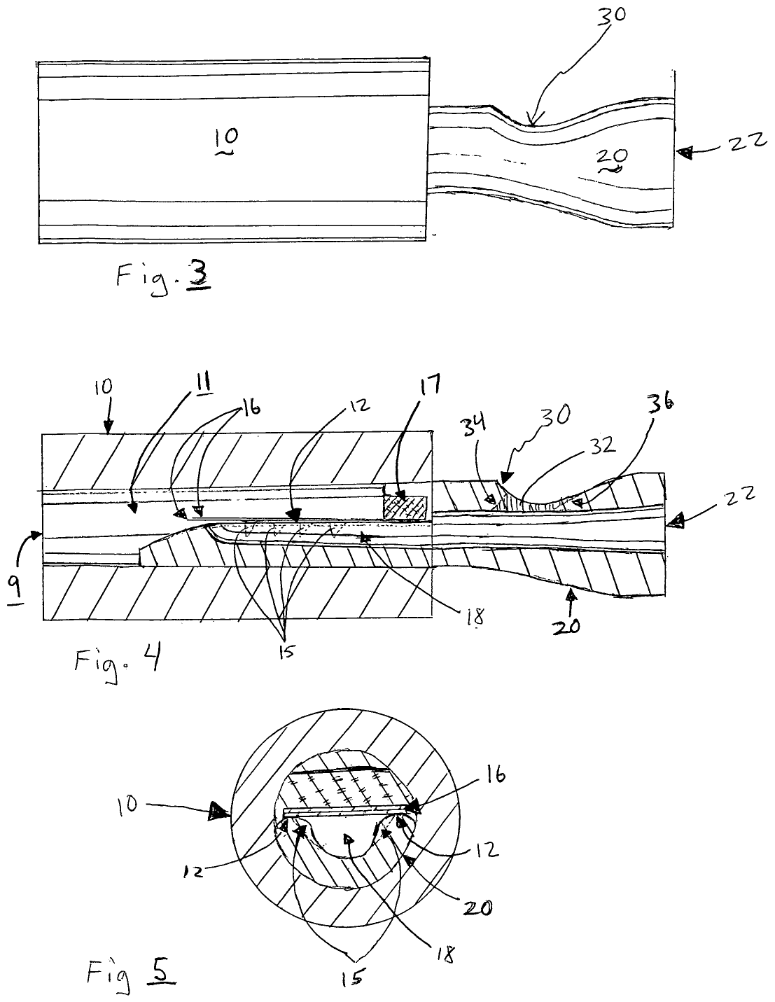

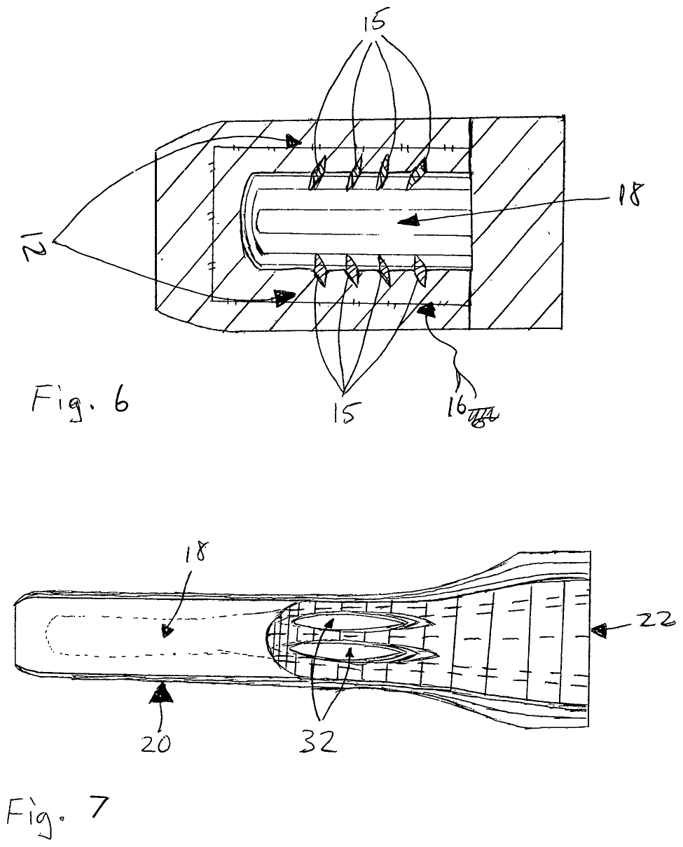

The exterior portion of the sounding barrel 20 outside of the blowing tube 10 includes a recessed surface area 30 around the secondary exhaust 32 shown in FIGS. 1, 2, 3, 4, and 7. The recessed portion 30 of the sounding barrel 20 has a steeper slope near but outside the blowing tube, while the recessed portion 30 of the sounding barrel 20 has a slighter slope from the secondary exhaust 32 slits toward the primary exhaust 22 of the sounding barrel allowing for air flow through the secondary exhaust 32 to be directed in a slightly lateral direction. The depth of the recession 30 allows for minimal thickness of the sounding barrel 20 between the secondary exhaust slits 32 and inner bore of primary air flow compared to wall thickness of the opposing bore side of the sounding barrel 20. The recession 30 carries crossways over the sounding barrel 20 compared to air flow, thus allowing the user of the described embodiment to orient the call properly to manually manipulate air flow through the secondary exhaust slits 32. Recession 30 can be of flat or moderately rounded design crossways compared to air flow through the sounding barrel 20. The recessed surface area 30 design feature serves four purposes: 1. It allows the operator to easily grasp the game caller device in the desired orientation based on feel. 2. The angular design projects the sounds coming through the secondary port in a forward direction, and 3. The recession reduces the thickness of material the secondary air flow moves through, increasing air flow through the secondary exhaust ports. 4. The designed recession depth enables the pitch of the game caller to still fall within the pitch range of live mallard hens, but allows for distinct difference in tones when the secondary exhaust 32 is open versus when it is closed, and variable control when the secondary exhaust 32 is throttled.

### CONCLUSION

The disclosed embodiments are illustrative, not restrictive. While specific configurations of the game caller have been described, it is understood that the present invention can be applied to a wide variety of game callers. There are many alternative ways of implementing the invention.

1. A mallard hen game caller: comprised of a blowing tube having a mouthpiece and two separate exhaust ports connected by a sound chamber inside the blowing tube, the blowing tube having an opening extending from the outside laterally into the sounding barrel, the mouthpiece having an opening through which the user blows and the air flow is discharged laterally through one primary exhaust and perpendicular through a secondary exhaust port, in which the secondary exhaust port can be manually manipulated to change pitch and tone of the game caller.

2. A mallard hen game caller: comprised of a blowing tube having a mouthpiece and at least one exhaust port connected by a sound chamber inside the blowing tube, the blowing tube having an opening extending from the outside laterally into the sounding barrel, the mouthpiece having one opening through which the user blows and the air flow is discharged laterally through at least one exhaust, a sounding barrel having an outer end and an inner end removably received in the opening in the discharge end of the blowing tube with the inner end extending into the blowing tube sound chamber toward the mouthpiece, the sounding barrel having a longitudinally extending bore terminating near the outer end of the sounding barrel in a sound channel, at least one reed combined with the sounding barrel member at its inner end near the mouthpiece of the blowing tube and extending over the bore in the sounding barrel, the reeds being supported by the reed support surface of the sounding barrel, the reed support surface having curvature as opposed to a flat surface, the reed support surface constituting diamond notches in a vertically angled design along the bore side, thus creating a lower surface area for the reeds to contact the sounding board while increasing perpendicular air flow forcing more upward lift against the reeds.

3. A mallard hen game caller: comprised of a blowing tube having a mouthpiece and two separate exhaust ports connected by a sound chamber inside the blowing tube, the blowing tube having an opening extending from the outside laterally into the sounding barrel, the mouthpiece having an opening through which the user blows and the air flow is discharged laterally through one primary exhaust and perpendicular through a secondary exhaust port, the perpendicular secondary exhaust port being designed as two longitudinal slits with a length to width ratio of approximately 5:1, the slits thus resembling the physiological characteristics of the connecting slits between the upper inside bill and nasal passage of a live mallard hen.

4. A mallard hen game caller: comprised of a blowing tube having a mouthpiece and two separate exhaust ports connected by a sound chamber inside the blowing tube, the blowing tube having an opening extending from the outside laterally into the sounding barrel, the mouthpiece having an opening through which the user blows and the air flow is discharged laterally through one primary exhaust and perpendicular through a secondary exhaust port, the secondary exhaust port located on a recessed portion of the sounding barrel near but outside the blowing tube.

5. A mallard hen game caller: comprised of a blowing tube having a mouthpiece and two separate exhaust ports connected by a sound chamber inside the blowing tube, the blowing tube having an opening extending from the outside laterally into the sounding barrel, the mouthpiece having an opening through which the user blows and the air flow is discharged laterally through one primary exhaust and perpendicular through a secondary exhaust port, the secondary exhaust port located on a recessed portion of the sounding barrel near but outside the blowing tube, the recessed portion of the sounding barrel having steeper angle near but outside the blowing tube, the recessed portion of the sounding barrel having slight angle from the secondary exhaust toward the primary exhaust of the sounding barrel, the depth of the recession allowing for minimal thickness of the sounding barrel between the slits and inner bore of primary air flow compared to wall thickness of the opposing bore side of the sounding barrel, the recession carried crossways over the sounding barrel compared to air flow, thus allowing the user of the described embodiment to orient the call properly to manually manipulate air flow through the secondary exhaust.
